(19) United States
(12) Patent Application Publication
(10) Pub. No.: US 2025/0166883 A1
(43) Pub. Date: May 22, 2025

(54) STRUCTURE AND METHOD FOR INDUCTOR WITH WINDINGS HAVING DIFFERENT WIDTHS

(71) Applicant: GlobalFoundries U.S. Inc., Malta, NY (US)

(72) Inventors: Patrick Rohlfs, Dresden (DE); Clarissa Cyrilla Prawoto, Dresden (DE)

(21) Appl. No.: 18/515,375

(22) Filed: Nov. 21, 2023

(51) Int. Cl. H01F 27/28; H01F 1/14

(52) U.S. Cl. CPC H01F 27/2828; H01F 1/14

(57) ABSTRACT

The disclosure provides a structure and method for an inductor with windings having different widths. A structure may include an inductor including a plurality of windings about a magnetic core. Each winding has a first segment within a first wiring layer coupled to a second segment within a second wiring layer. The plurality of windings includes a first winding having a first width along a same direction as a length of the magnetic core and a second winding having a second width along the same direction as the length of the magnetic core. The second width is larger than the first width.

### BACKGROUND

The present disclosure provides a structure and method for an inductor with windings having different widths.

Integration of soft magnetic materials (i.e., materials that can become magnetized or demagnetized at relatively low energy levels) into integrated circuits (ICs) has benefited device performance, particularly in the case of inductors, transformers, and/or other components which operate using magnetic fields. Components featuring soft magnetic materials, however, suffer from limitations in maximum current achievable in the device due to the saturation of magnetic flux produced from magnetic fields within the soft magnetic material(s). That is, the current may not increase beyond a particular maximum when the magnetic field strength in the inductor is too high, causing the inductor to be functionally indistinguishable from other implementations relying on air gaps and/or other open space as a medium for magnetic fields. Hybrid device structures combining soft magnetic materials with empty space may offer higher saturation currents but undesirably limit magnetic flux density.

### SUMMARY

The illustrative aspects of the present disclosure are designed to solve the problems herein described and/or other problems not discussed.

Embodiments of the disclosure provide a structure including: an inductor including a plurality of windings about a magnetic core, each winding having a first segment within a first wiring layer coupled to a second segment within a second wiring layer, wherein the plurality of windings includes: a first winding having a first width along a same direction as a length of the magnetic core, and a second winding having a second width along the same direction as the length of the magnetic core, wherein the second width is larger than the first width.

Other embodiments of the disclosure provide a structure including: a magnetic core extending a length over a substrate and within a pair of wiring layers of a device; and an inductor over the substrate and including a plurality of windings coupled together in series about the magnetic core, each winding having a first segment within a first wiring layer coupled to a second segment within a second wiring layer, the first segment and second segment defining a substantial V-shape, wherein the plurality of windings includes: a first winding having a first width along a same direction as the length of the magnetic core, and a second winding having a second width along the same direction as the length of the magnetic core, wherein the second width is larger than the first width.

Additional embodiments of the disclosure provide a method including: providing an inductor including a plurality of windings about a magnetic core, each winding having a first segment within a first wiring layer coupled to a second segment within a second wiring layer, wherein the plurality of windings includes: a first winding having a first width along a same direction as a length of the magnetic core, and a second winding having a second width along the same direction as the length of the magnetic core, wherein the second width is larger than the first width; and transmitting a current through the inductor to induce a magnetic flux within the magnetic core, wherein a flux density in a first portion of the magnetic core within the first winding is greater than a flux density in a second portion of the magnetic core within the second winding.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of a structure according to embodiments of the disclosure.

FIG. 2 shows a plan view of a structure according to embodiments of the disclosure.

FIG. 3 shows a lengthwise side view of a structure according to embodiments of the disclosure.

FIG. 4 shows a plan view of multiple inductor segments according to embodiments of the disclosure.

FIG. 5 shows a cross-sectional view of a magnetic core and inductor in two wiring levels of a device according to embodiments of the disclosure.

FIG. 6 shows a widthwise cross-sectional view of a structure according to embodiments of the disclosure.

FIG. 7 shows a plan view of a structure with annotated magnetic field regions during use in methods according to the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

In the following description, reference is made to the accompanying drawings that form a part thereof, and in which is shown by way of illustration specific illustrative embodiments in which the present teachings may be practiced. These embodiments are described in sufficient detail to enable those skilled in the art to practice the present teachings, and it is to be understood that other embodiments may be used and that changes may be made without departing from the scope of the present teachings. The following description is, therefore, merely illustrative.

It will be understood that when an element such as a layer, region, or substrate is referred to as being “on” or “over” another element, it may be directly on the other element or intervening elements may also be present. In contrast, when an element is referred to as being “directly on” or “directly over” another element, there may be no intervening elements present. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the phrases “in one embodiment” or “in an embodiment,” as well as any other variations appearing in various places throughout the specification are not necessarily all referring to the same embodiment. It is to be appreciated that the use of any of the following “/,” “and/or,” and “at least one of,” for example, in the cases of “A/B,” “A and/or B” and “at least one of A and B,” is intended to encompass the selection of the first listed option (a) only, or the selection of the second listed option (B) only, or the selection of both options (A and B). As a further example, in the cases of “A, B, and/or C” and “at least one of A, B, and C,” such phrasing is intended to encompass the first listed option (A) only, or the selection of the second listed option (B) only, or the selection of the third listed option (C) only, or the selection of the first and the second listed options (A and B), or the selection of the first and third listed options (A and C) only, or the selection of the second and third listed options (B and C) only, or the selection of all three options (A and B and C). This may be extended, as readily apparent by one of ordinary skill in the art, for as many items listed.

The disclosure provides a structure and method for an inductor with windings having different widths. A structure may include an inductor including a plurality of windings about a magnetic core. Each winding has a first segment within a first wiring layer coupled to a second segment within a second wiring layer. The plurality of windings includes a first winding having a first width along the same direction as a length of the magnetic core and a second winding having a second width along the same direction as the length of the magnetic core. The second width is larger than the first width. Transmitting a current through the inductor induces a magnetic flux within the magnetic core. The different widths in the first winding and the second winding cause flux density in the magnetic core to be larger within the first winding than within the second winding. Among other benefits, structures of the disclosure distribute flux density across a longer span of the magnetic core and thereby accommodate higher saturation currents.

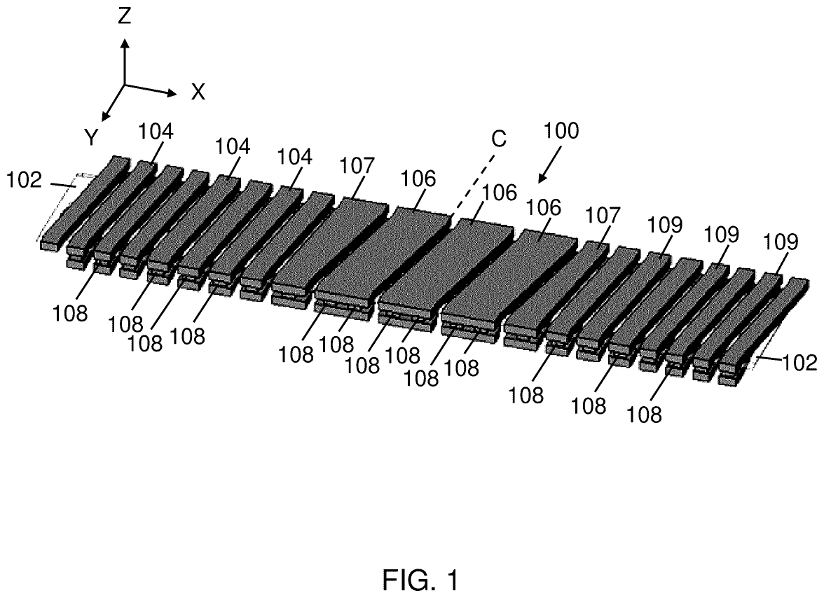

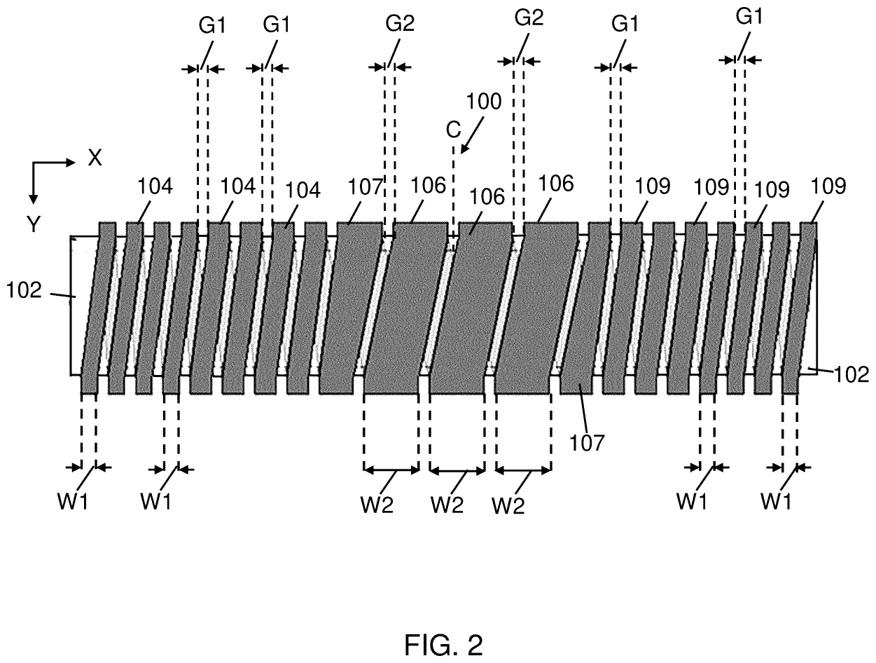

FIG. 1 provides a perspective view of an inductor 100 and FIG. 2 provides a plan view of inductor 100 in plane X-Y. Referring to FIGS. 1 and 2 together, embodiments of disclosure provide inductor 100, which may be integrated into an IC structure and/or various other microelectronic devices. Inductor 100 may surround a magnetic core 102, which may include any solid magnetic core material capable of being magnetized through the principles of inductance. Magnetic core 102 may be formed of one or more “soft magnetic materials,” i.e., currently known or later developed substances capable of exhibiting a magnetic field in response to relatively low amounts of inductive current in a wire thereon. Examples of materials appropriate for use within magnetic core 102 include, without limitation: cobalt-zirconium-tantalum alloys, iron-silicon alloys, nickel-iron alloys, ferrous (i.e., iron-based) materials such as “electronic iron,” steel and soft ferrite, amorphous and nano-crystalline alloys, etc. Magnetic core 102 is illustrated by example as being substantially rectangular and nearly planar (i.e., having negligible depth relative to length and width), but it is understood that magnetic core 102 may have any of a variety of other shapes (e.g., cylindrical geometries, prismatic geometries, etc.).

Inductor 100 may include a loop of conductive material (e.g., copper (Cu), aluminum (Al), and/or other materials suitable for use as conductive wires) configured to create a magnetic field to oppose increasing and decreasing electric currents within the span of inductor 100. Inductor 100, as discussed herein, may be subdivided into a plurality of individual windings (also known as “turns”) that together define a conductive loop within inductor 100. In various two-dimensional views of inductor 100 (e.g., the plan view of FIG. 2), it is emphasized that each winding may be oriented to extend into and out of the plane of the page to define multiple loops of conductive material, even when this is not directly visible in some perspectives.

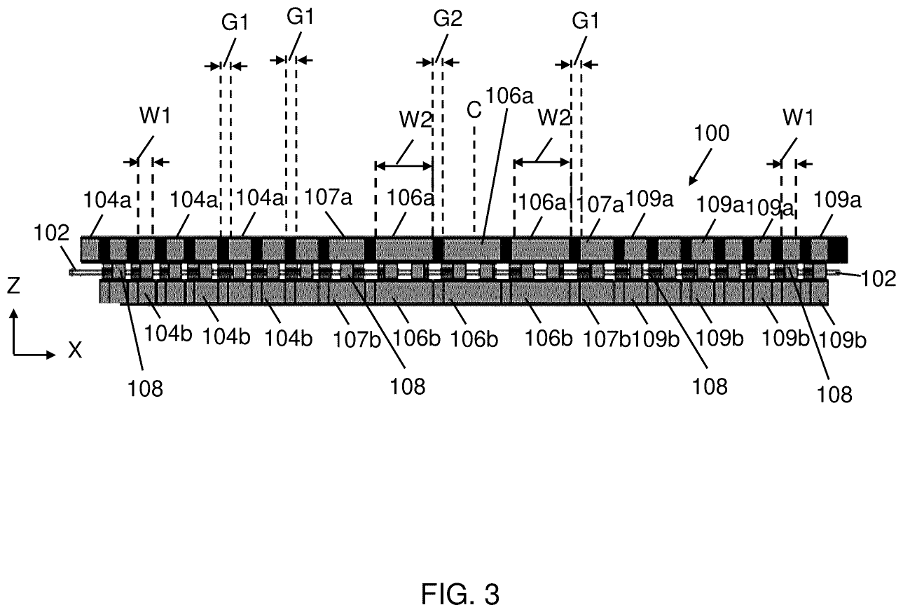

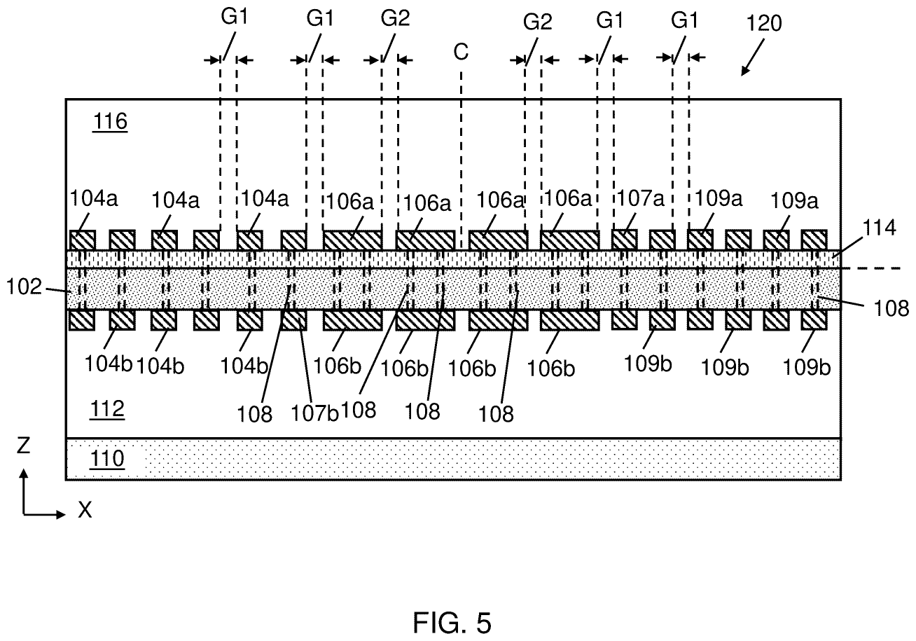

Referring to FIGS. 2 and 3 together, in which FIG. 3 provides a side view of inductor 100, inductor 100 includes a plurality of windings (e.g., first windings 104, transitional windings 107, second windings 106, and third windings 109) about magnetic core 102. Each of the various winding within inductor 100 may include a conductive material (e.g., copper (Cu), aluminum (Al), and/or other conductors discussed herein) and may include a set of substantially planar segments (e.g., segments 104a, 104b, 106a, 106b, 107a, 107b, 106a, 106b, 107a, 107b, 109a, 109b) and that cross the width of magnetic core 102 (i.e., the span of magnetic core 102 along the Y-axis). The various segments defining each winding 104, 106, 107, 109 of inductor 100 each may be within a respective wiring layer of an IC structure (e.g., as discussed elsewhere herein relative to FIG. 5). The various segments within each winding maybe connected together and/or to an adjacent winding through a vertical interconnect 108 spanning at least a portion of depth of magnetic core 102 (i.e., the span of magnetic core 102 along the Z-axis). In further implementations, it is understood that any or all of the various segments of inductor 100 may be structurally continuous yet distinguishable from each other based on relative size. Non-interconnected portions of inductor 100 are isolated from each other by one or more dielectric materials, e.g., ILD layers 112, 116 discussed herein. Each winding 104, 106, 107, 109 and segments thereof may be interconnected through vertical interconnects 108 so that inductor 100 may conduct current from one end (and terminal coupled thereto) to another.

First windings 104 of inductor 100 may have a first width W1 along the length of magnetic core 102. First width W1 in particular may be measured along the X-axis and may be measured in a direction parallel to the lengthwise span of magnetic core 102 along the X-axis. First width W1 may be, e.g., between approximately 70,000 nanometers (nm) and 90,000 nm, and a gap G1 between adjacent first windings 104 may be between approximately 5,000 nm and 15,000 nm. Each first winding 104 may have a substantially uniform first width W1 and a substantially uniform gap G1 therebetween. Inductor 100 also may have second windings 106 each having a second width W2 along the X-axis (i.e., in parallel with the length of magnetic core 102). Second width W2, as shown, is larger than first width W2 and may be approximately between approximately 150,000 and approximately 200,000 nm. Second windings 106 also may have substantially uniform gaps G2 therebetween, and each gap G2 between adjacent second windings 106 may be substantially uniform (e.g., between approximately 5,000 nm and 15,000 nm). The pitch of each winding 104, 106 (i.e., the sum of the width of one winding and the gap between that winding and the next winding) thus may vary throughout inductor 100, with first windings 104 having a smaller pitch than second windings 106. In embodiments where gaps G1, G2 are not uniform, first windings 104 each may have the same first pitch and second windings 106 each may have the same second pitch that is larger than the first pitch.

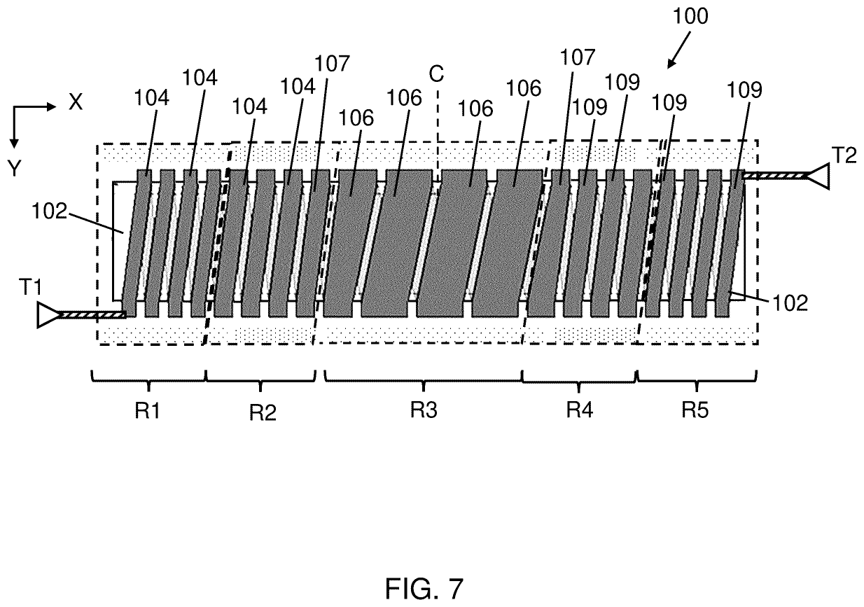

Second windings 106 may be closer to a center C (e.g., a lengthwise center along the X-axis as shown) of magnetic core 102 than any of first windings 104. During operation, the greater widths of second windings 106 may produce a lower magnetic flux density within magnetic core 102 than the magnetic flux density that is produced by first windings 104. The lower magnetic flux density within magnetic core 102 near center C, during operation, may desirably reduce the highest magnetic field strength by approximately twenty-five percent and thus more uniformly distribute the magnetic flux through magnetic core 102. These benefits can be realized without changing the current transmitted through inductor 100. Operational details and ensuing technical benefits are discussed in more detail herein relative to FIG. 7.

Inductor 100, as shown, includes one or more transition windings 107 between first winding(s) 104 and second winding(s) 106. Transition windings 107 may have a non-uniform width, such that a portion of transition winding 107 closer to first winding 104 may have a smaller width than a portion of transition winding 107 that is closer to second winding 106. Transition winding 107 may retain the same size gap G1 or G2 with first winding 104 and second winding 106, and thus the presence of transition winding 107 does not necessarily interfere with the uniformity of gaps G1, G2 (or the uniform pitches for each set of windings 104, 106, where applicable) within inductor 100.

Inductor 100 also may include a set of third windings 109, each being sized to have first width W1 (or alternately, the first pitch of first windings 104) along the length of magnetic core 102. Second windings 106 may be located between first windings 104 and third windings 109 along the length of magnetic core 102. Third windings 109 may be subdivided into segments 109a, 109b coupled together through vertical interconnects 108 in a manner similar to first windings 104 and second windings 106. One or more additional transition windings 107 may be between second windings 106 and third windings 109. Second windings 106 may produce a magnetic field in magnetic core 102 that is less dense than the magnetic fields produced by first windings 104 and third windings 109. By including second windings 106 between first windings 104 and third windings 109, the magnetic field density may be more uniformly distributed and less prone to undesirable increases in magnetic field density near center C of magnetic core 102. In turn, inductor 100 may accommodate higher currents before reaching its saturation state.

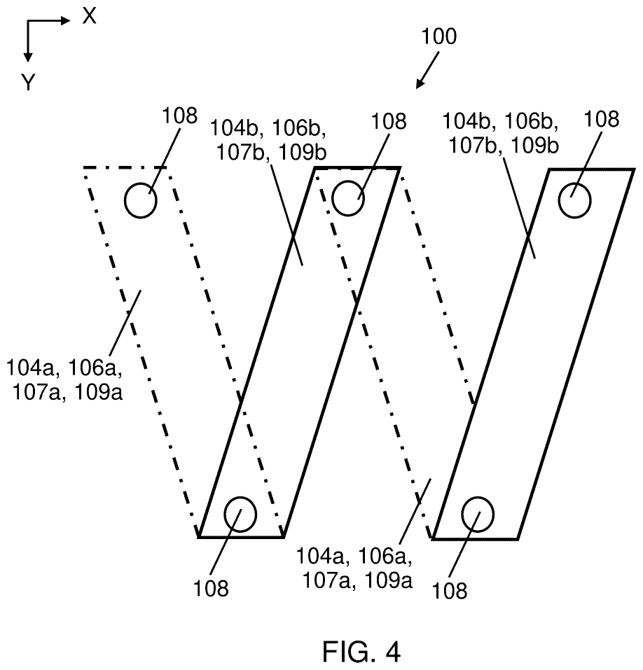

Referring to FIG. 4, segments 104a, 104b, 106a, 106b, 107a, 107b, 106a, 106b, 107a, 109a, 109b within different wiring layers may be arranged in a substantial V shape. That is, first segments 104a, 106a, 107a, 109a (shown in dashed lines to indicate a different horizontal plane) of a given winding may have a first orientation (e.g., upper-left to lower-right orientation as shown in FIG. 4) and second segments 104b, 106b, 107b, 109b may have a second orientation (e.g., lower-left to upper-right as shown in FIG. 4) to define the substantial V-shape. Each segment 104a, 104b, 106a, 106b, 107a, 107b, 106a, 106b, 107a, 109a, 109b thus may be substantially identical in size or shape but oriented differently to provide the desired shape of inductor 100. Although a substantial V-shape is shown in FIG. 4 to provide an example, it is understood that segments 104a, 104b, 106a, 106b, 107a, 107b, 106a, 106b, 107a, 109a, 109b may be non-linear or even non-curvilinear, and shapes other than a substantial V-shape are possible in further implementations.

FIG. 5 provides a cross-sectional view of inductor 100 structurally integrated into other components of a device. Inductor 100 may be over a substrate 110, e.g., one or more semiconductor materials. Substrate 110 may include but is not limited to silicon, germanium, silicon germanium, silicon carbide, or any other common IC semiconductor or packaging substrates. A portion or entire semiconductor substrate 110 may be strained. Substrate 110 is illustrated as a bulk semiconductor layer, but this is not required in all implementations. Substrate 110 may include various devices (e.g., transistors, capacitors, diodes, etc.) thereon in other locations not shown. A first inter-level dielectric (ILD) layer 112 may be on substrate 110. First ILD layer 112 may include any currently known or later developed insulating material appropriate for separating various layers of a device from each other, e.g., any material also appropriate for use as or within a trench isolation (TI) for electrically separating various regions of active semiconductor material. Such materials may include, without limitation: silicon nitride (Si₃N₄), silicon oxide (SiO₂), fluorinated SiO₂ (FSG), hydrogenated silicon oxycarbide (SiCOH), porous SiCOH, boro-phospho-silicate glass (BPSG), silsesquioxanes, carbon (C) doped oxides (i.e., organosilicates) that include atoms of silicon (Si), carbon (C), oxygen (O), and/or hydrogen (H), thermosetting polyarylene ethers, a spin-on silicon-carbon containing polymer material, near frictionless carbon (NFC), or layers thereof. However embodied, first ILD layer 112 may vertically separate active materials of inductor 100 from other active materials that may be on or within substrate 110, and/or other active or conductive components formed in various metal wiring layers in a device. Inductor 100 may be formed on first ILD layer 112, e.g., by removing portions of first ILD layer 112 material to a desired amount (e.g., by etching or other currently known or later developed processing techniques) and forming inductor 100 and magnetic core 102 on the remaining portions of first ILD layer 112.

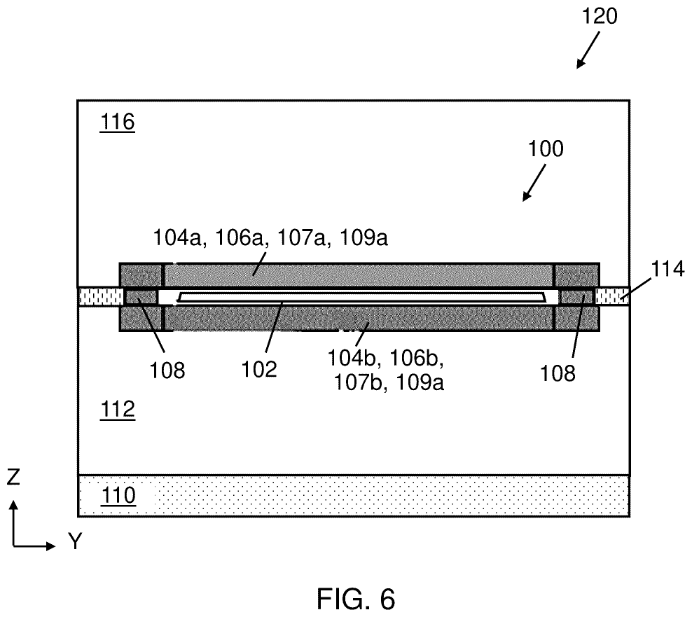

Referring to FIGS. 5 and 6 together, some portions of inductor 100 (e.g., magnetic core 102 and/or first segments 104a, 106a, 107a, 109a) may be in first ILD layer 112. Any component(s) within first ILD layer 112. FIGS. 5 and 6 each depict a cross-section of inductor 100 taken along a different two-dimensional plane, and through a portion of magnetic core 102. Vertical interconnects 108 may couple different segments of each winding together. Specifically, vertical interconnects 108 may couple segments 104a, 104b of first windings 104 together, other vertical interconnects 108 couple segments 106a, 106b of second windings 106 together, other vertical interconnects 108 couple segments 107a, 107b together, still other vertical interconnects 108 couple segments 109a, 109b of third windings 109 together, etc. Vertical interconnects 108 are shown in dashed lines to indicate that they are in a cross-section that is in front of, or behind, the plane illustrated in FIG. 5. To better distribute current through the differently sized windings 104, 106, 107, 109, segments 104a, 104b, 107a, 107b, or segments 109a, 109b of windings 104, 107 109, respectively, may be coupled together through a predetermined number of vertical interconnects 108 (e.g., a single vertical interconnect 108), whereas segments 106a, 106b of second windings 106 may be coupled through a larger number (e.g., two or more) vertical interconnects 108. Other numbers and arrangements of vertical interconnects 108 are also possible.

An insulative liner 114 may be on magnetic core 102 to vertically separate first ILD layer 112 from other layers formed thereover. Insulative liner 114 may include a different type of insulator from first ILD layer 112, e.g., it may include nitride in the case where first ILD layer 112 includes oxide insulators. Insulative liner 114, during processing, may function as “etch stop layers” to control where certain wires, vias, etc., will be formed in a structure and thus may define the upper boundary of a device layer or metal wiring layer thereover.

Portions of inductor 100 may be formed in different wiring layers. For example, inductor 100 may be distributed over a device layer and a metal wiring layer may be thereover, or otherwise may be distributed over two different metal wiring layers. FIG. 5 depicts the example of a device layer and a metal wiring layer thereover, but the description herein is equally applicable to inductors 100 formed in two metal wiring layers each having ILD material and insulative liner 114 therebetween. During manufacture, second segments 104b, 106b, 109b of windings 104, 106, 109 may be formed in first ILD layer 112. Magnetic core 102 and vertical interconnects 108 may be formed thereover, e.g., by repeated instances of forming and etching first ILD layer 112 and insulative liner 114. When the forming of first ILD layer 112 and insulative liner 114 concludes, inductor 100 may not yet be complete.

Before additional layers and/or insulative materials are formed over insulative liner 114, the forming of inductor 100 may include forming (e.g., by deposition) additional conductive material in the form of first segments 104a, 106a, 109a for each winding 104, 106, 109. First segments 104,a, 106a, 109a may be in another ILD on an upper surface of insulative liner 114 and may physically interface with the upper surfaces of vertical interconnects 108 formed through insulative liner 114 but may be vertically distal to magnetic core 102. Upon forming segments 104a, 106a, 109a, inductor 100 defines an electrically conductive pathway from one terminal to another and is operable to induce magnetic fields within magnetic core 102. Further processing may include forming a second ILD layer 116 over inductor 100 and insulative liner 114, thus forming an IC structure 120 having inductor 100 structurally integrated therein. The forming of segments 104a, 104b, 106a, 106b, 107a, 107b, 109a, 109b may include etching of ILD layer(s) 114, 116 to define the locations where conductive metals are formed, deposition of metals followed by planarization (e.g., chemical mechanical planarization (CMP), etc. Aspects of these processes may be controlled to provide varying widths and/or pitches in different segments 104a, 104b, 106a, 106b, 107a, 107b, 109a.

FIG. 7 depicts a plan view of inductor 100 during operation, in which an electric current is transmitted between opposing terminals T1, T2 of inductor 100. Terminals T1, T2 may be coupled to current sources and/or ground where applicable, and remaining components of a device are omitted from FIG. 7 solely for ease of illustration. According to an example, terminal T1 is coupled to a current source and terminal T2 is coupled to ground such that current flows from terminal T1 to terminal T2. Inductor 100, as structured according to the disclosure, may be subdivided into five regions: a first region R1 at the connection to terminal T1, a second region R2 coupled to region R1 opposite terminal T1, a third region R3 coupled to region R2, a fourth region R4 coupled to region R3, and a fifth region R5 coupled between fourth region R4 and terminal T2. Regions R1, R2, each may include first windings 104 of inductor 100. Additionally, region R2 may include one or more transition windings 107 discussed herein. Region R3, which includes center C of magnetic core 102, may include second windings 106. Region R4 may include transition winding(s) 107 and third winding(s) 109, and region R5 may include third winding(s) 109 coupled to terminal T2.

As discussed herein, the larger width of second windings 106 may produce a lower amount of magnetic flux (and thus flux density) in magnetic core 102 as a result of having fewer “turns” of conductive material in region R3. In a conventional inductor having turns of substantially uniform size or width, the magnetic field strength (measured, e.g., in amperes per meter (A/m)) may exceed 1500 A/m, or even be as high as 1900 A/m. These higher strength magnetic fields may appear at or near the center of the conventional inductor structure. Magnetic fields of such high strength may reduce the saturation (i.e., maximum allowed) current through an inductor, thus limiting its technical applications. Inductor 100 according to the disclosure can be employed in integrated in IC structures without exhibiting these unacceptably high magnetic field strengths. In embodiments of the disclosure, the peak magnetic field strength may be in regions R2, R4 may be at most approximately 1500 A/m, and more specifically may be between approximately 1300 A/m and approximately 1400 A/m. The higher magnetic field strength in regions R2, R4 may arise from the greater number of turns and/or distance of these regions from terminal(s) T1, T2. In regions R1, R3, R5, the magnetic field strength may be lower and may range from approximately 700 A/m to approximately 1200 A/M. The magnetic field strength through regions R1-R5 thus is more uniformly distributed than possible in conventional inductor structures formed around and/or relying on magnetic cores. These operational benefits arise from the different sizes of windings 104, 106, 107, 109 in each region as discussed herein, and in turn may allow higher amounts of current to pass through inductor 100 without the current saturating at an undesirably low magnitude. In contrast, conventional inductor structures have a maximum saturation current that is limited by the peak magnetic field strength that its windings produce. Thus, methods according to the disclosure include providing inductor 100 according to any embodiment herein, and passing a current through inductor 100 (e.g., from terminal T1 to terminal T2) to induce a magnetic flux within magnetic core 102. The flux density in a first portion of inductor 100 (e.g., region R2 or region R4 discussed herein) may be larger than the flux density in region R3 of inductor 100, which includes second winding(s) 106 and passes through center C of inductor 100.

Embodiments of the disclosure provide various technical and commercial advantages, examples of which are discussed herein. Embodiments of inductor 100 and/or IC structure 120 (FIGS. 5, 6) allow magnetic core 102 to be used in a product without limiting the maximum current in inductor 100 before saturation. These benefits may be achieved through windings 104, 106, 107, 109 of different widths and without forming slots and/or air gaps within inductor 100 or nearby components. As discussed herein, embodiments of the disclosure may decrease magnetic field density by approximately twenty-five percent in areas of inductor 100 that pass over, or are located near, center C where magnetic field strength would otherwise be highest. This, in turn, more uniformly distributes the magnetic field strength through magnetic core 102 during operation.

The method and structure as described above is used in the fabrication of integrated circuit chips. The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher-level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a center processor.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate+/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A structure comprising:
an inductor including a plurality of windings about a magnetic core, each winding having a first segment within a first wiring layer coupled to a second segment within a second wiring layer, wherein the plurality of windings includes:
a first winding having a first width along a same direction as a length of the magnetic core, and
a second winding having a second width along the same direction as the length of the magnetic core, wherein the second width is larger than the first width.

2. The structure of claim 1, wherein the second winding is closer to a center of the magnetic core than the first winding.

3. The structure of claim 1, wherein the plurality of windings further includes a third winding having the first width along the same direction as the length of the magnetic core, wherein the second winding is between the first winding and the third winding.

4. The structure of claim 1, wherein the plurality of windings further includes a transition winding between the first winding and the second winding, wherein the transition winding has a non-uniform width.

5. The structure of claim 1, wherein each pair of adjacent windings within the inductor has a substantially uniform gap along the length of the magnetic core.

6. The structure of claim 1, wherein the plurality of windings includes copper (Cu).

7. The structure of claim 1, wherein a single vertical interconnect couples the first segment to the second segment in the first winding, and a plurality of vertical interconnects couple the first segment to the second segment in the second winding.

8. A structure comprising:
a magnetic core extending a length over a substrate and within a pair of wiring layers of a device; and
an inductor over the substrate and including a plurality of windings coupled together in series about the magnetic core, each winding having a first segment within a first wiring layer coupled to a second segment within a second wiring layer, the first segment and second segment defining a substantial V-shape, wherein the plurality of windings includes:
a first winding having a first width along a same direction as the length of the magnetic core, and
a second winding having a second width along the same direction as the length of the magnetic core, wherein the second width is larger than the first width.

9. The structure of claim 8, wherein the second winding is closer to a center of the magnetic core than the first winding.

10. The structure of claim 8, wherein the plurality of windings further includes a third winding having the first width along the same direction as the length of the magnetic core, wherein the second winding is between the first winding and the third winding.

11. The structure of claim 8, wherein the plurality of windings further includes a transition winding between the first winding and the second winding, wherein the transition winding has a non-uniform width.

12. The structure of claim 8, wherein each pair of adjacent windings within the inductor has a substantially uniform gap along the length of the magnetic core.

13. The structure of claim 8, wherein the plurality of windings includes copper (Cu).

14. The structure of claim 8, wherein a single vertical interconnect couples the first segment to the second segment in the first winding, and a plurality of vertical interconnects couple the first segment to the second segment in the second winding.

15. A method comprising:
providing an inductor including a plurality of windings about a magnetic core, each winding having a first segment within a first wiring layer coupled to a second segment within a second wiring layer, wherein the plurality of windings includes:
a first winding having a first width along a same direction as a length of the magnetic core, and
a second winding having a second width along the same direction as the length of the magnetic core, wherein the second width is larger than the first width; and
transmitting a current through the inductor to induce a magnetic flux within the magnetic core, wherein a flux density in a first portion of the magnetic core within the first winding is greater than a flux density in a second portion of the magnetic core within the second winding.

16. The method of claim 15, wherein the second portion of the magnetic core is closer to a center of the magnetic core than the first portion of the magnetic core.

17. The method of claim 15, wherein the inductor further includes a third winding having the first width along the same direction as the length of the magnetic core, and wherein transmitting the current through the inductor causes a flux density in a third portion of the magnetic core within the third winding to be greater than the flux density in the second portion of the magnetic core.

18. The method of claim 15, wherein the plurality of windings further includes a transition winding between the first winding and the second winding, wherein the transition winding has a non-uniform width.

19. The method of claim 15, wherein each pair of adjacent windings within the inductor has a substantially uniform gap along the length of the magnetic core.

20. The method of claim 15, wherein a single vertical interconnect couples the first segment to the second segment in the first winding of the inductor, and a plurality of vertical interconnects couple the first segment to the second segment in the second winding of the inductor.
